(19) United States
(12) Patent Application Publication
(10) Pub. No.: US 2026/0002709 A1
(43) Pub. Date: Jan. 1, 2026

(54) LOW GWP FLUIDS FOR HIGH TEMPERATURE HEAT PUMP APPLICATIONS

(71) Applicant: HONEYWELL INTERNATIONAL INC., Charlotte, NC (US)

(72) Inventors: NITIN KARWA, Buffalo, NY (US); BRUNO YUJI KIMURA DE CARVALHO, Buffalo, NY (US); ANKIT SETHI, Buffalo, NY (US); RYAN HULSE, Buffalo, NY (US)

(73) Assignee: HONEYWELL INTERNATIONAL INC., Charlotte, NC (US)

(21) Appl. No.: 19/252,504

(22) Filed: Jun. 27, 2025

Related U.S. Application Data
(60) Provisional application No. 63/666,212, filed on Jun. 30, 2024.

(51) Int. Cl. F25B 30/02; C09K 5/04

(52) U.S. Cl. CPC F25B 30/02; C09K 5/044; C09K 5/045

(57) ABSTRACT

The present invention relates refrigerants which include HFO-1233zd. HFO-1234ze(E), and HFC-134a and the use of such refrigerants in high temperature heat pumps.

### CROSS REFERENCE TO RELATED APPLICATIONS

The present application claims the benefit of priority to U.S. Provisional Patent Application No. 63/666,212, filed Jun. 30, 2024, the disclosure of which is incorporated by reference in its entirety.

### FIELD OF THE INVENTION

This invention relates to compositions, methods and systems having utility in heat transfer applications, with particular benefit in high temperature heat pump applications, and in particular aspects to heat transfer and/or refrigerant compositions for replacement of or use instead of previously used refrigerants, including CFC-114, 1233zd(E) and 1234ze(Z), particularly for providing heating in high temperature heat pump systems.

### BACKGROUND

High temperature heat pumps have been used to upgrade low-grade thermal energy, such as that derived from air, soil, surface water or underground water, geothermal energy, solar energy, and industrial exhaust heat and process streams, to high-grade thermal energy via a thermodynamic cycle. Heat pump systems use a working fluid, i.e., a refrigerant, to facilitate the generation and transfer of heat over a vapor compression thermodynamic cycle. Heat pump systems have been used for both heating and cooling purposes.

Historically, chlorofluorocarbons were used as working fluids in heat pumps, refrigerators, and other heating/cooling devices and machines. For high temperature heat pumps, 1,2-dichloro-1,1,2,2-tetrafluoroethane (CFC-114) has been widely used. However, CFC has a very high Global Warming Potential (GMP) of over 10,000. While CFC-114 has been replaced in some applications by refrigerants such as R-134a, R-227ea, R-236fa, or R-245fa, the use of such materials present a significant disadvantage. For example, all of the above-noted refrigerants have relatively large GWPs, and R-134a and R-227ea have relatively low critical point temperatures, limiting their applicability to lower-temperature applications. As a result, there remains a continuing need for a more acceptable substitute for CFC-114 in high temperature heat pumps.

U.S. Pat. No. 10,101,065 also discloses the use of 1233zd(E), as well as 1233zd(Z), in high temperature heat pumps. HFO-1234ze(Z) possesses certain properties that show advantage in high temperature heat pump applications. However, it has been acknowledged that the information about HFO-1234ze(Z) is relatively scarce. (See “The fluorinated olefin R-1234ze(Z) as a high-temperature heat pumping refrigerant,” Brown et al., International Journal of Refrigeration, Volume 32, Issue 6, September 2009, Pages 1412-1422). In particular, applicants have come to appreciate that the lack of sufficient information about the toxicity and flammability of HFO-1234ze(Z), together with the fact that this compound has not been registered for use in any geographical region, make this compound at present less than fully satisfactory for use in high temperature heat pump applications. However, in high temperature heat pump applications its use represents a desirable target in terms of capacity and COP.

U.S. Pat. No. 9,850,414 discloses heat transfer composition comprising (1) from about 60% to less than about 100% by weight of a first composition selected from the group consisting of HFO-1233zd, HFC-245fa, and combinations of these; and (2) from greater than about 0% to about 40% by weight of a second composition selected from the group consisting of HFO-1234ze, HFC-134a, and combinations of these. The use in medium and high temperature heat pumps is mentioned. High temperature heat mumps are exemplified using binary compositions comprising 1233zd(E)/1234ze(E) and 1233zd(E)/134a are exemplified. No ternary compositions are exemplified.

U.S. Pat. No. 11,827,834 discloses refrigerant blends comprising: (a) carbon dioxide; (b) a nonflammable low volatility component selected from the group consisting of: HFO1224yd(Z), HFO1224yd(E), HFO1233zd(E), HFO1233zd(Z), HFO1233xf, HFO1336mzz(E), HFO1336mzz(Z), 2-bromo-3,3,3-trifluoroprop-1-ene; or mixtures thereof; (c) an intermediate volatility component selected from the group consisting of: HFO1234yf, HFO1234ze(E), HFO-1225ye(Z) and HFO1243zf or mixtures thereof; and (d) optionally a component selected from HFC-227ea, HFC-152a, HFC-32 or mixtures thereof.

Thus, applicants have come to appreciate the need for, and/or the potential substantial advantage to be achieved by, a working fluid in a high temperature heat pump that exhibits low ODP, low GWP, low flammability, low or no toxicity, and excellent thermal performance in the high temperature ranges (including preferably a capacity and COP that are relatively close matches to neat 1233zd(Z), particularly in systems that use a high heat sink temperature of about 60° C. or greater) to condense the refrigerant. Applicants have come to appreciate the need for use of such working fluids in new systems, but also a need for a working fluid that is advantageous as a replacement for and/or instead of CFC-114 and/or 1234zd(Z) in high temperature heat pump systems, especially a non-flammable refrigerant having a GWP less than 150 and at the same time is a close match to the capacity and COP of 1234zd(Z) in high temperature heat pump systems, which can potentially provide a substantial savings in installed cost and potentially maintenance costs over the life of the installation as a replacement for CFC-114 and/or 1233zd(E).

These and/or other needs are satisfied by the inventive refrigerants, systems and methods described in detail herein.

### SUMMARY

Applicants have unexpectedly and advantageously found, as described in detail herein, that compositions based on carefully selected amounts of the combination of HFO-1233zd(E), HFO-1234ze(E) and HFC-134a can provide refrigerants that satisfy many, and preferably all, of the requirements discussed above, as well additional requirements and/or advantages as described hereinafter.

Applicants have discovered refrigerants, heat transfer compositions, refrigeration methods and systems, which utilize one or more of the compositions of the present invention as a refrigerant, including and especially in connection with high temperature heat pump applications.

The present invention includes refrigerants consisting essentially of the following three components in the following relative concentrations:
(1) from 72% to 85.5% by weight of HFO-1233zd(E);
(2) from 4.5% to 28% by weight of HFO-1234ze(E); and
(3) from 1% to 11% by weight of HFC-134a.
   The refrigerant according to this paragraph is sometimes referred to herein for convenience as Refrigerant 1A.

The present invention includes refrigerants consisting of:
(1) from 72% to 85.5% by weight of HFO-1233zd(E);
(2) from 4.5% to 28% by weight of HFO-1234ze(E); and
(3) from 1% to 11% by weight of HFC-134a.
   The refrigerant according to this paragraph is sometimes referred to herein for convenience as Refrigerant 1B.

The present invention includes refrigerants consisting of:
(1) from 72% to 85.5% by weight of HFO-1233zd(E);
(2) from 4.5% to 28% by weight of HFO-1234ze(E); and
(3) from 1% to 11% by weight of HFC-134a,
   provided that the refrigerant is a Class A1 refrigerant and has a GWP of 150 or less. The refrigerant according to this paragraph is sometimes referred to herein for convenience as Refrigerant 1C.

The present invention includes refrigerants consisting essentially of the following three components in the following relative concentrations:
(1) from 77% to 83% by weight of HFO-1233zd(E);
(2) from 7% to 21% by weight of HFO-1234ze(E); and
(3) from 2% to 11% by weight of HFC-134a.

The refrigerant according to this paragraph is sometimes referred to herein for convenience as Refrigerant 2A.

The present invention includes refrigerants consisting of:
(1) from 77% to 83% by weight of HFO-1233zd(E);
(2) from 7% to 21% by weight of HFO-1234ze(E); and
(3) from 2% to 11% by weight of HFC-134a.
   The refrigerant according to this paragraph is sometimes referred to herein for convenience as Refrigerant 2B.

The present invention includes refrigerants consisting of:
(1) from 77% to 83% by weight of HFO-1233zd(E);
(2) from 7% to 21% by weight of HFO-1234ze(E); and
(3) from 2% to 11% by weight of HFC-134a,
   provided that the refrigerant is a Class A1 refrigerant and has a GWP of 150 or less. The refrigerant according to this paragraph is sometimes referred to herein for convenience as Refrigerant 2C.

The present invention includes refrigerants consisting essentially of the following three components in the following relative concentrations:
(1) from 83% to 86% by weight of HFO-1233zd(E);
(2) from 4% to 9% by weight of HFO-1234ze(E); and
(3) from 7% to 10.3% by weight of HFC-134a.

The refrigerant according to this paragraph is sometimes referred to herein for convenience as Refrigerant 3A.

The present invention includes refrigerants consisting of:
(1) from 83% to 86% by weight of HFO-1233zd(E);
(2) from 4% to 9% by weight of HFO-1234ze(E); and
(3) from 7% to 10.3% by weight of HFC-134a.

The refrigerant according to this paragraph is sometimes referred to herein for convenience as Refrigerant 3B.

The present invention includes refrigerants consisting essentially of the following three components in the following relative concentrations:
(1) from about 79% to about 82% by weight of HFO-1233zd(E);
(2) from about 8% to about 11% by weight of HFO-1234ze(E); and
(3) from about 9% to about 11% by weight of HFC-134a.

The refrigerant according to this paragraph is sometimes referred to herein for convenience as Refrigerant 4A.

The present invention includes refrigerants consisting of:
(1) from about 79% to about 82% by weight of HFO-1233zd(E);
(2) from about 8% to about 11% by weight of HFO-1234ze(E); and
(3) from about 9% to about 11% by weight of HFC-134a.

The refrigerant according to this paragraph is sometimes referred to herein for convenience as Refrigerant 4B.

The present invention includes refrigerants consisting essentially of the following three components in the following relative concentrations:
(1) from about 79.5% to about 82.5% by weight of HFO-1233zd(E);
(2) from about 7.5% to about 10.5% by weight of HFO-1234ze(E); and
(3) from about 9.5% to about 10.5% by weight of HFC-134a.

The refrigerant according to this paragraph is sometimes referred to herein for convenience as Refrigerant 5A.

The present invention includes refrigerants consisting of:
(1) from about 79.5 to about 82.5% by weight of HFO-1233zd(E);
(2) from 7.5% to about 10.5% by weight of HFO-1234ze(E); and
(3) from about 9.5% to about 10.5% by weight of HFC-134a.

The refrigerant according to this paragraph is sometimes referred to herein for convenience as Refrigerant 5B.

The present invention includes refrigerants consisting essentially of the following three components in the following relative concentrations:
(1) from 79.5% to 82.5% by weight of HFO-1233zd(E);
(2) from 7.5% to 8% by weight of HFO-1234ze(E); and
(3) from about 9.5% to about 10.5% by weight of HFC-134a.

The refrigerant according to this paragraph is sometimes referred to herein for convenience as Refrigerant 5C.

The present invention includes refrigerants consisting of:
(1) from 79.5 to 82.5% by weight of HFO-1233zd(E);
(2) from 7.5% to 8% by weight of HFO-1234ze(E); and
(3) from 9.5% to 10.5% by weight of HFC-134a.

The refrigerant according to this paragraph is sometimes referred to herein for convenience as Refrigerant 5D.

The present invention includes refrigerants consisting essentially of the following three components in the following relative concentrations:
(1) about 82.2% by weight of HFO-1233zd(E);
(2) about 7.8% by weight of HFO-1234ze(E); and
(3) about 10% by weight of HFC-134a.

The refrigerant according to this paragraph is sometimes referred to herein for convenience as Refrigerant 5E.

The present invention includes refrigerants consisting of:
(1) about 82.2% by weight of HFO-1233zd(E);
(2) about 7.8% by weight of HFO-1234ze(E); and
(3) about 10% by weight of HFC-134a.

The refrigerant according to this paragraph is sometimes referred to herein for convenience as Refrigerant 5F.

The present invention includes refrigerants consisting essentially of the following three components in the following relative concentrations:
(1) 82.2% by weight of HFO-1233zd(E);
(2) 7.8% by weight of HFO-1234ze(E); and
(3) 10% by weight of HFC-134a.

The refrigerant according to this paragraph is sometimes referred to herein for convenience as Refrigerant 5G.

The present invention includes refrigerants consisting of:
(1) 82.2% by weight of HFO-1233zd(E);
(2) 7.8% by weight of HFO-1234ze(E); and
(3) 10% by weight of HFC-134a.

The refrigerant according to this paragraph is sometimes referred to herein for convenience as Refrigerant 5F.

The present invention includes refrigerants consisting essentially of the following three components in the following relative concentrations:
(1) from 77% to 80.5% by weight of HFO-1233zd(E);
(2) from 8.5% to 20.5% by weight of HFO-1234ze(E); and
(3) from 2.5% to 10.3% by weight of HFC-134a.

The refrigerant according to this paragraph is sometimes referred to herein for convenience as Refrigerant 6A.

The present invention includes refrigerants consisting of:
(1) from 77% to 80.5% by weight of HFO-1233zd(E);
(2) from 8.5% to 20.5% by weight of HFO-1234ze(E); and
(3) from 2.5% to 10.3% by weight of HFC-134a.

The refrigerant according to this paragraph is sometimes referred to herein for convenience as Refrigerant 6B.

The present invention also includes methods of providing heating to a heat sink in a high temperature heat pump comprising:
(1) providing a vapor compression refrigeration system comprising a compressor for compressing a refrigerant in a vapor phase, a condenser transferring heat from said vapor phase refrigerant to the heat sink at a temperature of from about 70° C. to about 145° C. and a direct expansion evaporator transferring heat from a heat source at a temperature of from about 30° C. to about 90° C. to said refrigerant in the liquid phase, wherein said refrigerant comprises:
   a. from 72% to about 85.5% by weight of HFO-1233zd(E);
   b. from 4.5% to 28% by weight of HFO-1234ze(E); and
   c. from 1% to 11% by weight of HFC-134a,
wherein said refrigerant has (i) a Global Warming Potential (GWP) of 150 or less; (ii) a Class A1 flammability; and (iii) a critical temperature of greater than 150° C.; and
(2) evaporating said refrigerant in said direct expansion evaporator, wherein said refrigerant has a volumetric capacity in said system that is at least about 120% of the volumetric capacity of R-1233zd(E) in said system.
   The method according to this paragraph is sometimes referred to herein for convenience as Heat Transfer Method 1A.

The present invention also includes methods of providing heating to a heat sink in a high temperature heat pump comprising:
(1) providing a vapor compression refrigeration system comprising a compressor for compressing a refrigerant in a vapor phase, a condenser transferring heat from said vapor phase refrigerant to the heat sink at a temperature of from about 70° C. to about 145° C. and a direct expansion evaporator transferring heat from a heat source at a temperature of from about 30C to about 90° C. to said refrigerant in the liquid phase, wherein said refrigerant comprises:
   a. from 72% to about 85.5% by weight of HFO-1233zd(E);
   b. from 4.5% to 28% by weight of HFO-1234ze(E); and
   c. from 1% to 11% by weight of HFC-134a,
wherein said refrigerant has (i) a Global Warming Potential (GWP) of 150 or less; (ii) a Class A1 flammability; and (iii) a critical temperature of greater than 150° C.; and
(2) evaporating said refrigerant in said direct expansion evaporator, wherein: (i) said refrigerant has a volumetric capacity in said system that is at least about 120% of the volumetric capacity of R-1233zd(E) in said system; and (ii) said refrigerant has an evaporator glide in said system of less than 4° C.
   The method according to this paragraph is sometimes referred to herein for convenience as Heat Transfer Method 1B.

The present invention also includes methods of providing heating to a heat sink in a high temperature heat pump comprising:
(1) providing a vapor compression refrigeration system comprising a compressor for compressing a refrigerant in a vapor phase, a condenser transferring heat from said vapor phase refrigerant to the heat sink at a temperature of from about 70° C. to about 130° C., a vapor injection economizer and a direct expansion evaporator transferring heat from a heat source at a temperature of from about 30° C. to about 90° C. to said refrigerant in the liquid phase, wherein said refrigerant comprises:
   a. from 72% to about 85.5% by weight of HFO-1233zd(E);
   b. from 4.5% to 28% by weight of HFO-1234ze(E); and
   c. from 1% to 11% by weight of HFC-134a,
wherein said refrigerant has (i) a Global Warming Potential (GWP) of 150 or less; (ii) a Class A1 flammability; and (iii) a critical temperature of greater than 150° C.; and
(2) evaporating said refrigerant in said direct expansion evaporator, wherein: (i) said refrigerant has a volumetric capacity in said system that is at least about 120% of the volumetric capacity of R-1233zd(E) in said system; and (ii) said refrigerant has a COP in said system that is at least about 96% of the COP of R-1233zd(E) in said system.
   The method according to this paragraph is sometimes referred to herein for convenience as Heat Transfer Method 1C.

The present invention also includes methods of providing heating to a heat sink in a high temperature heat pump comprising:
(1) providing a vapor compression refrigeration system comprising a compressor for compressing a refrigerant in a vapor phase, a condenser transferring heat from said vapor phase refrigerant to the heat sink at a temperature of from about 70° C. to about 145° C., a vapor injection economizer and a direct expansion evaporator transferring heat from a heat source at a temperature of from about 30° C. to about 90° C. to said refrigerant in the liquid phase, wherein said refrigerant comprises:
   a. from 72% to about 85.5% by weight of HFO-1233zd(E);
   b. from 4.5% to 28% by weight of HFO-1234ze(E); and
   c. from 1% to 11% by weight of HFC-134a,
wherein said refrigerant has (i) a Global Warming Potential (GWP) of 150 or less; (ii) a Class A1 flammability; and (iii) a critical temperature of greater than 150° C.; and
(2) evaporating said refrigerant in said direct expansion evaporator, wherein: (i) said refrigerant has a volumetric capacity in said system that is at least about 120% of the volumetric capacity of R-1233zd(E) in said system; (ii) said refrigerant has a COP in said system that is at least about 96% of the COP of R-1233zd(E) in said system and (iii) said refrigerant has an evaporator glide in said system of less than 4° C.
   The method according to this paragraph is sometimes referred to herein for convenience as Heat Transfer Method 1D.

The present invention also includes methods of providing heating to a heat sink in a high temperature heat pump comprising:
(1) providing a vapor compression refrigeration system comprising a compressor for compressing a refrigerant in a vapor phase, a condenser transferring heat from said vapor phase refrigerant to the heat sink at a temperature of from about 70° C. to about 145° C. and a direct expansion evaporator transferring heat from a heat source at a temperature of from about 30° C. to about 90° C. to said refrigerant in the liquid phase, wherein said refrigerant comprises:
   a. about 82.2% by weight of HFO-1233zd(E);
   b. about 7.8% by weight of HFO-1234ze(E); and
   c. about 10% by weight of HFC-134a,
wherein said refrigerant has (i) a Global Warming Potential (GWP) of 150 or less; (ii) a Class A1 flammability; and (iii) a critical temperature of greater than 150° C.; and
(2) evaporating said refrigerant in said direct expansion evaporator, wherein said refrigerant has a volumetric capacity in said system that is at least about 120% of the volumetric capacity of R-1233zd(E) in said system.
   The method according to this paragraph is sometimes referred to herein for convenience as Heat Transfer Method 1E.

The present invention also includes methods of providing heating to a heat sink in a high temperature heat pump comprising:
(1) providing a vapor compression refrigeration system comprising a compressor for compressing a refrigerant in a vapor phase, a condenser transferring heat from said vapor phase refrigerant to the heat sink at a temperature of from about 70° C. to about 145° C. and a direct expansion evaporator transferring heat from a heat source at a temperature of from about 30° C. to about 90° C. to said refrigerant in the liquid phase, wherein said refrigerant is any one of Refrigerants 1-6; and
(2) evaporating said refrigerant in said direct expansion evaporator, wherein said refrigerant has a volumetric capacity in said system that is at least about 120% of the volumetric capacity of R-1233zd(E) in said system.
   The method according to this paragraph is sometimes referred to herein for convenience as Heat Transfer Method 1F.

The present invention also includes a method of reducing the cost of forming a high temperature heat pump system for providing heat to a heat sink comprising a fluid or body to be heated comprising:
(1) providing a vapor compression refrigeration system comprising:
   a. a compressor for compressing a refrigerant in a vapor phase, wherein said compressor has a displacement which is at least about 15% less than the compressor displacement required to achieve the same capacity in said system using a refrigerant consisting of R-1234ze(E);
      b. a condenser transferring heat, directly or indirectly, from said vapor phase refrigerant to the heat sink, wherein said heat sink is at a temperature of from about 70° C. about 145° C., and
      c. a direct expansion evaporator transferring heat, directly or indirectly, from a heat source, wherein said heat source is at a temperature of from about 30° C. to about 70° C., to said refrigerant in the liquid phase, wherein said refrigerant consists essentially of the following three components in the following relative concentrations:
         i. from 77% to about 82% by weight of HFO-1233zd(E);
         ii. from 7% to 22% by weight of HFO-1234ze(E); and
         iii. from 2% to about 11% by weight of HFC-134a,
   provided that said refrigerant is Class A1; and
(2) providing a vapor economizer to said vapor compression refrigeration system; and
(3) evaporating said refrigerant in said direct expansion evaporator, wherein said refrigerant: (i) has a COP in said system that is at least 96% of the COP of R-1233zd(Z) in said system; and (ii) has a capacity in said system that is at least 120% of the capacity of R-1233zd(E) in said system.
   The method according to this paragraph is sometimes referred to herein for convenience as Heat Pump Cost Reduction Method 1A.

The present invention also includes a method of reducing the cost of forming a high temperature heat pump system for providing heat to a heat sink comprising a fluid or body to be heated comprising:
(1) providing a vapor compression refrigeration system comprising:
   a. a compressor for compressing a refrigerant in a vapor phase, wherein said compressor has a displacement which is at least about 15% less than the compressor displacement required to achieve the same capacity in said system using a refrigerant consisting of R-1234ze(E);
      b. a condenser transferring heat, directly or indirectly, from said vapor phase refrigerant to the heat sink, wherein said heat sink is at a temperature of from about 70° C. about 145° C., and
      c. a direct expansion evaporator transferring heat, directly or indirectly, from a heat source, wherein said heat source is at a temperature of from about 30° C. to about 70° C., to said refrigerant in the liquid phase, wherein said refrigerant is any one of Refrigerants 1-6;
(2) providing a vapor economizer to said vapor compression refrigeration system; and
(3) evaporating said refrigerant in said direct expansion evaporator, wherein said refrigerant: (i) has a COP in said system that is at least 96% of the COP of R-1233zd(Z) in said system; and (ii) has a capacity in said system that is at least 120% of the capacity of R-1233zd(E) in said system.
   The method according to this paragraph is sometimes referred to herein for convenience as Heat Pump Cost Reduction Method 1B.

The present invention includes a vapor compression heat pump providing heat to a heat sink comprising a fluid or body to be heated comprising:
(1) a refrigerant;
(2) a compressor for compressing said refrigerant in a vapor phase and a vapor injector economizer providing for the compressor;
(3) a condenser transferring heat from said vapor phase refrigerant, directly or indirectly, to the heat sink at a temperature of from about 70° C. to about 145° C.; and
(4) a direct expansion evaporator transferring heat from a heat source at a temperature of from about 30° C. to about 70° C. to said refrigerant in the liquid phase,
(5) wherein said refrigerant consists essentially of the following three components in the following relative concentrations:
   i. from 77% to 85% by weight of HFO-1233zd(E);
   ii. from 7% to 22% by weight of HFO-1234ze(E); and
   iii. from 2% to 11% by weight of HFC-134a,
wherein said refrigerant: (a) is a Class A1; and (b) has a capacity in said system that is at least about 120% of the capacity of R-1233zd(E) in said system.

The heat pump according to this paragraph is sometimes referred to herein for convenience as Heat Pump 1A.

The present invention includes a vapor compression heat pump providing heat to a heat sink comprising a fluid or body to be heated comprising:
(1) a refrigerant;
(2) a compressor for compressing said refrigerant in a vapor phase and a vapor injector economizer providing for the compressor;
(3) a condenser transferring heat from said vapor phase refrigerant, directly or indirectly, to the heat sink at a temperature of from about 70° C. to about 145° C.; and
(4) a direct expansion evaporator transferring heat from a heat source at a temperature of from about 30° C. to about 70° C. to said refrigerant in the liquid phase,
(5) wherein said refrigerant consists essentially of the following three components in the following relative concentrations:
   i. from 77% to 83% by weight of HFO-1233zd(E);
   ii. from 7% to 22% by weight of HFO-1234ze(E); and
   iii. from 2% to 11% by weight of HFC-134a,
wherein said refrigerant: (a) is a Class A1; and (b) has a COP in said system that is at least about 96% of the COP of R-1233zd(E) in said system.
   The heat pump according to this paragraph is sometimes referred to herein for convenience as Heat Pump 1B.

The present invention includes a vapor compression heat pump providing heat to a heat sink comprising a fluid or body to be heated comprising:
(1) a refrigerant;
(2) a compressor for compressing said refrigerant in a vapor phase;
(3) a condenser transferring heat from said vapor phase refrigerant, directly or indirectly, to the heat sink at a temperature of from about 70° C. to about 130° C. and thereby condensing at least a portion of said refrigerant vapor to refrigerant liquid; and
(4) at least one expander for reducing the pressure of said liquid refrigerant from said condenser;
(5) an direct expansion evaporator transferring heat from a heat source at a temperature of from about 30° C. to about 145° C. to said refrigerant in the liquid phase,
(6) wherein said refrigerant consists essentially of the following three components in the following relative concentrations:
   i. from 77% to 83% by weight of HFO-1233zd(E);
   ii. from 7% to 22% by weight of HFO-1234ze(E); and
   iii. from 2% to 11% by weight of HFC-134a,
wherein said refrigerant: (a) is a Class A1; (b) has a COP in said system that is at least about 96% of the COP of R-1233zd(Z) in said system; and (c) has a capacity in said system that is at least about 120% of the capacity of R-1233zd(Z) in said system.
   The heat pump according to this paragraph is sometimes referred to herein for convenience as Heat Pump 1C.

The present invention includes a vapor compression heat pump providing heat to a heat sink comprising a fluid or body to be heated comprising:
(1) a refrigerant;
(2) a compressor for compressing said refrigerant in a vapor phase and a vapor injector economizer providing for the compressor;
(3) a condenser transferring heat from said vapor phase refrigerant, directly or indirectly, to the heat sink at a temperature of from about 70° C. to about 145° C.; and
(4) a direct expansion evaporator transferring heat from a heat source at a temperature of from about 30° C. to about 70° C. to said refrigerant in the liquid phase,
(5) wherein said refrigerant consists essentially of the following three components in the following relative concentrations:
   i. from 81.5% to 82.5% by weight of HFO-1233zd(E);
   ii. from 7.5% to 8% by weight of HFO-1234ze(E); and
   iii. from 9% to 11% by weight of HFC-134a,
wherein said refrigerant: (a) is a Class A1; and (b) has a capacity in said system that is at least about 120% of the capacity of R-1233zd(E) in said system.
   The heat pump according to this paragraph is sometimes referred to herein for convenience as Heat Pump 1D.

The present invention includes a vapor compression heat pump providing heat to a heat sink comprising a fluid or body to be heated comprising:
(1) a refrigerant;
(2) a compressor for compressing said refrigerant in a vapor phase and a vapor injector economizer providing for the compressor;
(3) a condenser transferring heat from said vapor phase refrigerant, directly or indirectly, to the heat sink at a temperature of from about 70° C. to about 145° C.; and
(4) a direct expansion evaporator transferring heat from a heat source at a temperature of from about 30° C. to about 70° C. to said refrigerant in the liquid phase,
(5) wherein said refrigerant consists essentially of the following three components in the following relative concentrations:
   i. about 82.2% by weight of HFO-1233zd(E);
   ii. about 7.8% by weight of HFO-1234ze(E); and
   iii. about 10% by weight of HFC-134a,
wherein said refrigerant: (a) is a Class A1; and (b) has a capacity in said system that is at least about 120% of the capacity of R-1233zd(E) in said system.
   The heat pump according to this paragraph is sometimes referred to herein for convenience as Heat Pump 1E.

The present invention includes a vapor compression heat pump providing heat to a heat sink comprising a fluid or body to be heated comprising:
(1) a refrigerant;
(2) a compressor for compressing said refrigerant in a vapor phase and a vapor injector economizer providing for the compressor;
(3) a condenser transferring heat from said vapor phase refrigerant, directly or indirectly, to the heat sink at a temperature of from about 70° C. to about 145° C.; and
(4) a direct expansion evaporator transferring heat from a heat source at a temperature of from about 30° C. to about 70° C. to said refrigerant in the liquid phase,
(5) wherein said refrigerant is one of Refrigerants 1-8.
   The heat pump according to this paragraph is sometimes referred to herein for convenience as Heat Pump 1F.

### BRIEF DESCRIPTION OF THE FIGURES

FIG. 1 is a schematic representation of an exemplary heat transfer system that can be used with the present refrigerants, and which can be used in the present systems and methods, including high temperature heat pump systems and methods.

FIG. 2 is a schematic representation of an exemplary heat transfer system which includes a vapor injector economizer and that can be used with the present refrigerants, and which can be used in the present systems and methods, including high temperature heat pump systems and methods.

FIG. 3 is a schematic representation of an exemplary heat transfer system which includes a suction line heat exchanger that can be used with the present refrigerants, and which can be used in the present systems and methods, including high temperature heat pump systems and methods.

### DETAILED DESCRIPTION

### Definitions

The phrase “coefficient of performance” (herein abbreviated as “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration, cooling or heating capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “Global Warming Potential” (herein abbreviated as “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. As used herein, the term GWP means the value of GWP as measured in accordance with IPCC Fourth Assessment Report, 20141, referred to and abbreviated herein as AR4, except for components that did not have a GWP value measured in AR4 (such as R1233zd(E) and R1234ze(E)), then the values used are according to the Fifth Assessment Report. ¹Myhre, G., D. Shindell, F.-M. Bréon, W. Collins, J. Fuglestvedt, J. Huang, D. Koch, J.-F. Lamarque, D. Lee, B. Mendoza, T. Nakajima, A. Robock, G. Stephens, T. Takemura and H. Zhang, 2013: Anthropogenic and Natural Radiative Forcing. In: Climate Change 2013: The Physical Science Basis. Contribution of Working Group I to the Fifth Assessment Report of the Intergovernmental Panel on Climate Change [Stocker, T. F., D. Qin, G.-K. Plattner, M. Tignor, S. K. Allen, J. Boschung, A. Nauels, Y. Xia, V. Bex and P. M. Midgley (eds.)]. Cambridge University Press, Cambridge, United Kingdom and New York, NY, USA. https://www.ipcc.ch/pdf/assessmentreport/ar5/wg1/WG1AR5_Chapter08_FINAL.pdf (p. 73-79)

The term “non-flammable” as used herein refers to compounds or compositions which are determined to be either class 1 or 2L under ASHRAE 34-2016 test protocol defining conditions and apparatus and using the current method ASTM E681-09 annex A1. Accordingly, a refrigerant which is not classified as either Class 1 or Class 2L under ASHRAE 34-2016 test protocol defining conditions and apparatus and using the current method ASTM E681-09 annex A1 would be considered flammable herein. ASTM Standard E-681-2009 Standard Test Method for Concentration Limits of Flammability of Chemicals (Vapors and Gases) at conditions described in ASHRAE Standard 34-2016 Designation and Safety Classification of Refrigerants and described in Appendix B1 to ASHRAE Standard 34-2016 (as each standard exists as of the filing date of this application), are incorporated herein by reference in their entireties.

The phrase “acceptable toxicity” as used herein means the composition is classified as class “A” by ASHRAE Standard 34-2016 Designation and Safety Classification of Refrigerants and described in Appendix B1 to ASHRAE Standard 34-2016 (as each standard exists as of the filing date of this application). A substance which is non-flammable and acceptable-toxicity, or mildly flammable and acceptable-toxicity, would be classified as “A1” or as “A2L” by ASHRAE Standard 34-2016 Designation and Safety Classification of Refrigerants and described in Appendix B1 to ASHRAE Standard 34-2016 (as each standard exists as of the filing date of this application).

As the term is used herein, “replacement for” with respect to a particular heat transfer composition or refrigerant of the present invention as a “replacement for” a particular prior refrigerant means the use of the indicated composition of the present invention in a heat transfer system that heretofore had been commonly used with that prior refrigerant. By way of example, when a refrigerant or heat transfer composition of the present invention is used in a heat transfer system that has heretofore been designed for and/or commonly used with R410A, such as residential air conditioning and commercial air conditioning (including roof top systems, variable refrigerant flow (VRF) systems and chiller systems) then the present refrigerant is a replacement for R410A is such systems.

The term “degree of superheat” or simply “superheat” means the temperature rise of the refrigerant at the exit of the evaporator above the saturated vapor temperature (or dew temperature) of the refrigerant.

As used herein, the term “evaporator glide” means the difference between the saturation temperature of the refrigerant at the entrance to the evaporator and the dew point of the refrigerant at the exit of the evaporator, assuming the pressure at the evaporator exit is the same as the pressure at the inlet. As used herein, the phrase ‘saturation temperature” means the temperature at which the liquid refrigerant boils into vapor at a given pressure.

As used herein, the terms “direct expansion evaporator” and “Dx Evaporator” means a heat exchanger which receives a zeotropic liquid refrigerant blend and produces an unfractionated, superheated vapor of said zeotropic refrigerant blend.

As used herein, the term “flooded evaporator” means a heat exchanger which transfers heat to a boiling reservoir of liquid refrigerant.

As used herein, the term “district heating” means a system or method for heating a plurality of closely located residential spaces, such as in high rise apartment complexes, using a shared heat source loop or a series of shared heat source loops, such as one or a series of geothermal ground bore loops.

As used herein, the term “shallow geothermal heat source” means heat extracted from the earth at depths of from 2 meters to 500 meters.

As used herein, the term “condenser glide” means the difference between the dew point temperature of the refrigerant at or near the entrance to the condenser and the saturation temperature of the refrigerant at or near the exit of the condenser, assuming the pressure at the condenser exit is the same as the pressure at the inlet. As used herein, the phrase ‘saturation temperature” means the temperature at which the liquid refrigerant boils into vapor at a given pressure.

As used herein, the term “refrigerant” is used broadly to encompass fluids that function to transfer heat during heat transfer operations, whether heating or cooling, or as working fluids in ORC systems.

As used herein, the term “heat transfer composition” is used broadly to encompass fluids that include a refrigerant and are involved in heat transfer operations, whether heating or cooling, or as working fluids in ORC systems.

The terms “1234ze” and “HFO-1234ze,” and “R1234ze” as used herein each means 1,1,1,3-tetrafluoropropene, without limitation as to isomeric form.

The terms trans1234ze, 1234ze(E), and R-1234ze(E) as used herein each means trans1,3,3,3-tetrafluoropropene.

The terms cis1234ze and 1234ze(Z) as used herein each means cis1,3,3,3-tetrafluoropropene.

The terms 1233zd as used herein means 1-chloro-3,3,3-trifluoropropene, without limitation as to isomeric form.

The terms trans1233zd and 1233zd(E) as used herein each means trans1-chloro-3,3,3-trifluoropropene.

The terms cis1233zd and 1233zd(Z) as used herein each means cis1-chloro-3,3,3-trifluoropropene.

The term “R-134a” and “HFC-134a” as used herein each means 1,1,1,2-tetrafluoroethane.

As used herein the terms “high temperature heat pump system” and “high temperature heat pump” means a vapor compression system operable in a heating mode in which the condensing temperature of the refrigerant is about 800C or higher.

As used herein, reference to a defined group, such as “Refrigerant 1-6,” refers to each composition within that group, including wherein a definition number includes a suffix. For example, reference to Refrigerant 1-2 includes reference to each of Refrigerant 1A, Refrigerant 1B, Refrigerant 1C, Refrigerant 2A, Refrigerant 2B and Refrigerant 2C.

As used herein, the term “about” in relation to the amount expressed in weight percent means that the amount of the component can vary by an amount of +/−10% on a relative basis by weight. Thus, if an amount is described as being “about 10 wt. %,” then it is intended to cover amounts of 10 wt. %+/−1 wt. %, and if an amount is described as being “about 20 wt. %,” then it is intended to cover amounts of 20 wt. %+/−2 wt. %, etc.

### Heat Pumps

A high temperature heat pump (sometimes referred to herein for convenience as “HTHP”) in its basic configuration comprises a fluid circuit which utilizes a circulating refrigerant to take-up or absorb heat from at least a first reservoir of heat (sometimes referred to herein as a “heat source”) at a relatively low temperature (sometimes referred to herein for convenience as a “low temperature heat source”) and then emitting or transmitting heat to at least a second reservoir which absorbs the heat (sometimes referred to herein as a heat sink) at a relatively high temperature (sometimes referred to herein for convenience as a “high temperature heat sink”). In preferred configurations the low temperature heat source is a plentiful source of heat at a relatively low temperature, such as might be available from low temperature industrial waste heat, geothermal energy from the ground and/or ground water, and the like, and the high temperature heat sink is a fluid which is desired to maintain in a relatively higher temperature range, such as hot water or steam or hot air.

The temperature of the low temperature heat source to be used in connection with the present refrigerants, systems and methods can vary widely, but in preferred embodiments will provide heat at temperatures of from about 5° C. to about 90° C., or from about 25° C. to about 90° C., or from about 40° C. to about 90° C., or from about 50° C. to about 90° C., or from about 40° C. to about 80° C., or from about 30° C. to about 80° C. or from about 5C to about 20° C., or from about 5° C. to about 15° C. Examples of low temperature heat sources useful in connection with the present invention include low grade industrial heat, air from the environment, water from the environment, brine, and in the case of geothermal energy, from the earth, including ground water.

With respect to the high temperature heat sinks which can absorb heat according to the present invention, the present invention is believed to be useful for a wide range of such heat sinks, including hot air, hot water (i.e., hot water at a temperature of at least about 55° C.), and steam. The temperature of the high temperature heat sink to be used in connection with the present refrigerants, systems and methods can vary widely, but in preferred embodiments will absorb heat at a temperatures of from about 70° C. to about 145° C., or from about 70° C. to about 140° C., or from about 70° C. to about 135° C., or from about 70° C. to about 130° C., or from about 70° C. to about 120° C., or from about 70° C. to about 110° C., or from about 70° C. to about 100° C.

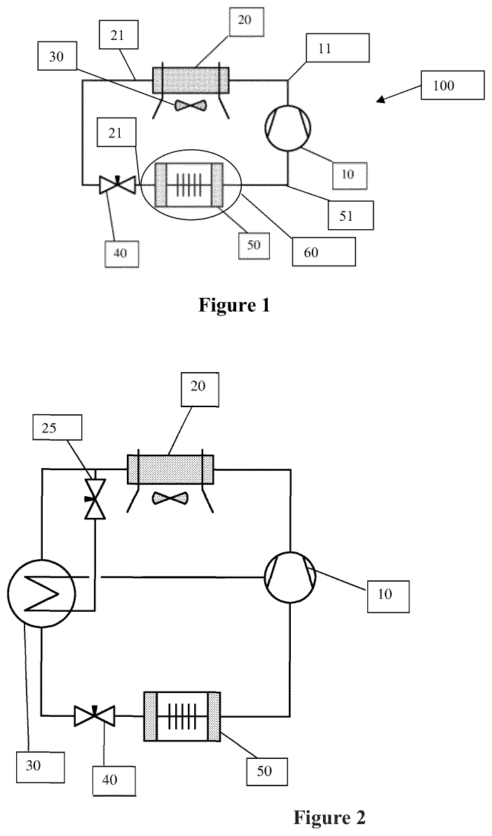

FIG. 1 is a generalized schematic view of a basic high-temperature heat pump device which contains and operates with the refrigerants of the present invention, including each of Refrigerants 1 to 6.

FIG. 1 illustrates in block diagram form a HTHP 100 according to the present invention includes an evaporator 50 that receives heat from the low temperature heat source (represented schematically by the oval 60), including by undergoing a phase change from liquid to vapor as heat is absorbed from the low temperature heat source. It will be appreciated, however, that some level of sensible heat may also transferred to the refrigerants of the present invention, including each of Refrigerants 1-76 by the low temperature heat source. The vaporous refrigerant which exits evaporator 50 via line 51 is introduced to the suction side of compressor 10 which adds work to the refrigerant and increases both the temperature and the pressure of the refrigerant vapor. This high temperature vapor from the compressor 10 is transported via line 11 to the condenser 20 in which the refrigerant of the present invention, including each of Refrigerants 1-6, supplies heat at a relatively high temperature to the high temperature heat sink, which is represented schematically (but not by way of limitation) by fan 30. The condensed refrigerant of the present invention then is transported by line 21 to a pressure reducing device, such as an expansion valve, 40 where the pressure of the liquid refrigerant is reduced, thus producing relatively low temperature liquid refrigerant, which is then introduced via line 41 to the condenser, where the cycle begins again.

An alternative but preferred embodiment of the present HTHP of the present invention is illustrated generally in FIG. 2. In this embodiment, the basic structure of the HTHP as described above is used, except a vapor injector economizer, represented schematically by the combination of the expansion valve 25 and heat exchanger 30, is used. In this arrangement, a portion of the liquid refrigerant of the present invention, including each of Refrigerants 1-6, exiting from the condenser 20 flows through the expansion valve 25 to produce a relative cool, low pressure liquid that feeds heat exchanger 30. In heat exchanger 30, the cool low pressure liquid absorbs heat from the relatively warm condenser liquid by vaporizing to form a relatively low pressure refrigerant vapor which then enters into a suction side of the compressor 10. The condenser liquid which has been cooled in the vapor injector economizer then proceeds to the expansion valve 40.

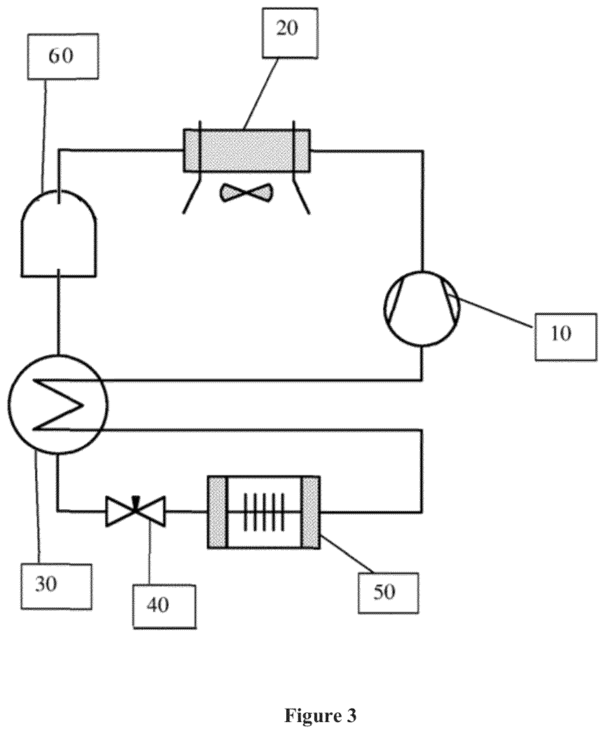

Another alternative but preferred embodiment of the present HTHP of the present invention is illustrated generally in FIG. 3. In this embodiment, the basic structure of the HTHP as described above in FIG. 1 is used, except a suction line heat exchanger (SLHX) 30 is used. In this arrangement, at least a portion of the liquid refrigerant of the present invention, including each of Refrigerants 1-6, exiting from the condenser 20 flow to an accumulator and/or oil separator 60 and then to SLHX 30 wherein heat is introduced into the feed line to the compressor 10. The heat transfer fluid, including heat transfer compositions including Refrigerants 1-6, exiting the SLHX 30 then is introduced to the expansion valve 25 to produce a relative cool, low pressure liquid that feeds heat exchanger 50. In heat exchanger 50, the cool low pressure liquid absorbs heat from the relatively warm condenser liquid by vaporizing to form a relatively low pressure refrigerant vapor which then, after passing through the SLHX 30, enters into a suction side of the compressor 10.

The specific type of equipment used in the present heat pump systems can vary widely within the scope of the present invention. For example, the compressor can be of centrifugal, screw and positive displacement type. In preferred aspects, the high temperature heat pump systems of the present invention, including each of Heat Transfer Methods 1, Heat Pumps 1, and HTHP Method Nos. 1-66, comprise one or more single state centrifugal compressors and/or one or more multistage centrifugal compressors, and combinations of one or more single stage and one or more multistage centrifugal compressors. In certain aspects, particularly those centrifugal compressor(s) as described in the previous paragraph, a vapor injector economizer (VIE) is used. In certain aspects, particularly those centrifugal compressor(s) as described in the previous paragraph which comprise one or more multistage compressors, the VIE introduces vapor to the compressor between one or more of said multiple stages. In certain aspects, particularly those centrifugal compressor(s) as described in the previous paragraph which comprise one or more 2 stage compressors, a VIE is provided which introduces vapor to the compressor at least between the first and second stage. In certain aspects, particularly those centrifugal compressor(s) as described in the previous paragraph which comprise one or more 3 stage compressors, a VIE is provided which introduces vapor to the compressor at least between the first and second stage and/or at least between the second and third stage.

With respect to the heat exchangers 20, 30 and 50, applicants note that the preferred refrigerants of the present invention have condenser glides and evaporator glides of from about 3° C. to less than about 15° C., and for the use of the refrigerants of the present invention, including each of Refrigerants 1-6, it is preferred that counter-current and/or cross current flow heat exchangers are used for evaporator(s) and the condenser(s). Applicants have come to appreciate that the use of such heat exchangers in the systems and methods as described herein allow advantageous use of glide matching with the heat sink or heat source. Furthermore, the use of heat exchangers that do not permit fractionation during evaporation or condensation are preferred, and accordingly flooded heat exchangers are preferably not used on the refrigerant side and instead heat exchangers such as brazed plate heat exchangers, and similar heat exchangers which do not permit fractionation of refrigerant, are preferred. For example, if shell and tube heat exchangers are used for either the condenser or the evaporator, it is highly preferred that the refrigerant flows through the tubes in the heat exchanger and not on the shell side. Thus, the heat exchangers 20, 30 and 50 of the present systems and methods are preferably a dry expansion or direct expansion type (and not a flooded type) and in the case of the evaporator 50 produce a vapor with a super heat of at least about 5° C. and in the case of the condenser 20 a liquid with subcooling at least about 5° C.

The type of expansion device used can vary. The expansion device can be an expansion valve, which can be electronic or thermostatic as needed by the specifics of the design. This description does not limit any possible additional variances for the specific equipment or the use of additional components that are not illustrated in FIG. 1, such as suction line heat exchangers, vapor ejectors and the like.

The following Table 1 identifies preferred high temperature heat pump method of the present invention (identified by the HTHP Method numbers in column 1) using: (1) the refrigerants of the present invention (identified in column 2 by numbers corresponding to the Refrigerant Numbers defined above); (2) a direct expansion evaporator; (3) a vapor injector economizer; and (4) having the operating parameters as specified in the table.

HIGH TEMPERATURE HEAT PUMP METHOD CONDITIONS

| HTHP | | | LTHS | High | HTHS. | Performance, % | |
|---|---|---|---|---|---|---|---|
| Method | Refrig. | Low Temp. | Temp., | Temp. | Temp., | 1233zd(E) | |
| No. | No. | Heat Source | ° C. | Heat Sink | ° C. | COP | Capacity |
| 1A | 1A | Industrial | 30-90 | Industrial | 110-145 | =>95 | =>125 |
| | | waste heat | | Steam | | | |
| 1B | 1A | Industrial | 30-90 | Low | 115-130 | =>95 | =>125 |
| | | waste heat | | Pressure | | | |
| | | | | Steam | | | |
| 10 | 1A | Industrial | 30-90 | Hot water | 50-70 | =>95 | =>125 |
| | | waste heat | | | | | |
| 1D | 1A | Industrial | 30-90 | Hot air | 35-60 | =>95 | =>125 |
| | | waste heat | | | | | |
| 2A | 1A | Industrial | 30-90 | Industrial | 110-145 | =>95 | =>125 |
| | | waste heat | | Steam | | | |
| | | from data | | | | | |
| | | centers | | | | | |
| 2B | 1A | Industrial | 30-90 | Low | 115-130 | =>95 | =>125 |
| | | waste heat | | Pressure | | | |
| | | from data | | Steam | | | |
| | | centers | | | | | |
| 2C | 1A | Industrial | 30-90 | Hot water | 50-70 | =>95 | =>125 |
| | | waste heat | | | | | |
| | | from data | | | | | |
| | | centers | | | | | |
| 2D | 1A | Industrial | 30-90 | Hot air | 35-60 | =>95 | =>125 |
| | | waste heat | | | | | |
| | | from data | | | | | |
| | | centers | | | | | |
| 3A | 1A | Industrial | 30-90 | Industrial | 110-145 | =>95 | =>125 |
| | | waste heat | | Steam | | | |
| | | from data | | | | | |
| | | centers | | | | | |
| 3B | 1A | Industrial | 30-90 | Low | 115-130 | =>95 | =>125 |
| | | waste heat | | Pressure | | | |
| | | from data | | Steam | | | |
| | | centers | | | | | |
| 3C | 1A | Industrial | 30-90 | Hot water | 50-70 | =>95 | =>125 |
| | | waste heat | | | | | |
| | | from data | | | | | |
| | | centers | | | | | |
| 3D | 1A | Industrial | 30-90 | Hot air | 35-60 | =>95 | =>125 |
| | | waste heat | | | | | |
| | | from data | | | | | |
| | | centers | | | | | |
| 4A | 1A | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 4B | 1A | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 4C | 1A | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 4D | 1A | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 5A | 1A | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 5B | 1A | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 5C | 1A | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 5D | 1A | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 6A | 1A | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 6B | 1A | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 6C | 1A | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 6D | 1A | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |
| 7A | 1B | Industrial | 30-90 | Industrial | 110-145 | =>95 | =>125 |
| | | waste heat | | Steam | | | |
| 7B | 1B | Industrial | 30-90 | Low | 115-130 | =>95 | =>125 |
| | | waste heat | | Pressure | | | |
| | | | | Steam | | | |
| 7C | 1B | Industrial | 30-90 | Hot water | 50-70 | =>95 | =>125 |
| | | waste heat | | | | | |
| 7D | 1B | Industrial | 30-90 | Hot air | 35-60 | =>95 | =>125 |
| | | waste heat | | | | | |
| 8A | 1B | Industrial | 30-90 | Industrial | 110-145 | =>95 | =>125 |
| | | waste heat | | Steam | | | |
| | | from data | | | | | |
| | | centers | | | | | |
| 8B | 1B | Industrial | 30-90 | Low | 115-130 | =>95 | =>125 |
| | | waste heat | | Pressure | | | |
| | | from data | | Steam | | | |
| | | centers | | | | | |
| 8C | 1B | Industrial | 30-90 | Hot water | 50-70 | =>95 | =>125 |
| | | waste heat | | | | | |
| | | from data | | | | | |
| | | centers | | | | | |
| 8D | 1B | Industrial | 30-90 | Hot air | 35-60 | =>95 | =>125 |
| | | waste heat | | | | | |
| | | from data | | | | | |
| | | centers | | | | | |
| 9A | 1B | Industrial | 30-90 | Industrial | 110-145 | =>95 | =>125 |
| | | waste heat | | Steam | | | |
| | | from data | | | | | |
| | | centers | | | | | |
| 9B | 1B | Industrial | 30-90 | Low | 115-130 | =>95 | =>125 |
| | | waste heat | | Pressure | | | |
| | | from data | | Steam | | | |
| | | centers | | | | | |
| 9C | 1B | Industrial | 30-90 | Hot water | 50-70 | =>95 | =>125 |
| | | waste heat | | | | | |
| | | from data | | | | | |
| | | centers | | | | | |
| 9D | 1B | Industrial | 30-90 | Hot air | 35-60 | =>95 | =>125 |
| | | waste heat | | | | | |
| | | from data | | | | | |
| | | centers | | | | | |
| 10A | 1B | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 10B | 1B | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 10C | 1B | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 10D | 1B | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 11A | 1B | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 11B | 1B | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 11C | 1B | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 11D | 1C | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 12A | 1C | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 12B | 1C | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 12C | 1C | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 12D | 1C | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |
| 13A | 1C | Industrial | 30-90 | Industrial | 110-145 | =>95 | =>125 |
| | | waste heat | | Steam | | | |
| 13B | 1C | Industrial | 30-90 | Low | 115-130 | =>95 | =>125 |
| | | waste heat | | Pressure | | | |
| | | | | Steam | | | |
| 13C | 1C | Industrial | 30-90 | Hot water | 50-70 | =>95 | =>125 |
| | | waste heat | | | | | |
| 13D | 1C | Industrial | 30-90 | Hot air | 35-60 | =>95 | =>125 |
| | | waste heat | | | | | |
| 14A | 1C | Industrial | 30-90 | Industrial | 110-145 | =>95 | =>125 |
| | | waste heat | | Steam | | | |
| | | from data | | | | | |
| | | centers | | | | | |
| 14B | 1C | Industrial | 30-90 | Low | 115-130 | =>95 | =>125 |
| | | waste heat | | Pressure | | | |
| | | from data | | Steam | | | |
| | | centers | | | | | |
| 14C | 1C | Industrial | 30-90 | Hot water | 50-70 | =>95 | =>125 |
| | | waste heat | | | | | |
| | | from data | | | | | |
| | | centers | | | | | |
| 14D | 1C | Industrial | 30-90 | Hot air | 35-60 | =>95 | =>125 |
| | | waste heat | | | | | |
| | | from data | | | | | |
| | | centers | | | | | |
| 15A | 1C | Industrial | 30-90 | Industrial | 110-145 | =>95 | =>125 |
| | | waste heat | | Steam | | | |
| | | from data | | | | | |
| | | centers | | | | | |
| 15B | 1C | Industrial | 30-90 | Low | 115-130 | =>95 | =>125 |
| | | waste heat | | Pressure | | | |
| | | from data | | Steam | | | |
| | | centers | | | | | |
| 15C | 1C | Industrial | 30-90 | Hot water | 50-70 | =>95 | =>125 |
| | | waste heat | | | | | |
| | | from data | | | | | |
| | | centers | | | | | |
| 15D | 1C | Industrial | 30-90 | Hot air | 35-60 | =>95 | =>125 |
| | | waste heat | | | | | |
| | | from data | | | | | |
| | | centers | | | | | |
| 16A | 1C | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 16B | 1C | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 16C | 1C | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 16D | 1C | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 17A | 1C | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 17B | 1C | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 17C | 1C | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 17D | 1C | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 18A | 1C | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 18B | 1C | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 18C | 1C | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 18D | 1C | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |
| 19A | 2A | Industrial | 30-90 | Industrial | 110-145 | =>95 | =>125 |
| | | waste heat | | Steam | | | |
| 19B | 2A | Industrial | 30-90 | Low | 115-130 | =>95 | =>125 |
| | | waste heat | | Pressure | | | |
| | | | | Steam | | | |
| 19C | 2A | Industrial | 30-90 | Hot water | 50-70 | =>95 | =>125 |
| | | waste heat | | | | | |
| 19D | 2A | Industrial | 30-90 | Hot air | 35-60 | =>95 | =>125 |
| | | waste heat | | | | | |
| 20A | 2A | Industrial | 30-90 | Industrial | 110-145 | =>95 | =>125 |
| | | waste heat | | Steam | | | |
| | | from data | | | | | |
| | | centers | | | | | |
| 20B | 2A | Industrial | 30-90 | Low | 115-130 | =>95 | =>125 |
| | | waste heat | | Pressure | | | |
| | | from data | | Steam | | | |
| | | centers | | | | | |
| 20C | 2A | Industrial | 30-90 | Hot water | 50-70 | =>95 | =>125 |
| | | waste heat | | | | | |
| | | from data | | | | | |
| | | centers | | | | | |
| 20D | 2A | Industrial | 30-90 | Hot air | 35-60 | =>95 | =>125 |
| | | waste heat | | | | | |
| | | from data | | | | | |
| | | centers | | | | | |
| 21A | 2A | Industrial | 30-90 | Industrial | 110-145 | =>95 | =>125 |
| | | waste heat | | Steam | | | |
| | | from data | | | | | |
| | | centers | | | | | |
| 21B | 2A | Industrial | 30-90 | Low | 115-130 | =>95 | =>125 |
| | | waste heat | | Pressure | | | |
| | | from data | | Steam | | | |
| | | centers | | | | | |
| 21C | 2A | Industrial | 30-90 | Hot water | 50-70 | =>95 | =>125 |
| | | waste heat | | | | | |
| | | from data | | | | | |
| | | centers | | | | | |
| 21D | 2A | Industrial | 30-90 | Hot air | 35-60 | =>95 | =>125 |
| | | waste heat | | | | | |
| | | from data | | | | | |
| | | centers | | | | | |
| 22A | 2A | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 22B | 2A | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 22C | 2A | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 22D | 2A | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 23A | 2A | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 23B | 2A | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 23C | 2A | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 23D | 2A | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 24A | 2A | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 24B | 2A | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 24C | 2A | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 24D | 2A | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |
| 25A | 2B | Industrial | 30-90 | Industrial | 110-145 | =>95 | =>125 |
| | | waste heat | | Steam | | | |
| 25B | 2B | Industrial | 30-90 | Low | 115-130 | =>95 | =>125 |
| | | waste heat | | Pressure | | | |
| | | | | Steam | | | |
| 25C | 2B | Industrial | 30-90 | Hot water | 50-70 | =>95 | =>125 |
| | | waste heat | | | | | |
| 25D | 2B | Industrial | 30-90 | Hot air | 35-60 | =>95 | =>125 |
| | | waste heat | | | | | |
| 26A | 2B | Industrial | 30-90 | Industrial | 110-145 | =>95 | =>125 |
| | | waste heat | | Steam | | | |
| | | from data | | | | | |
| | | centers | | | | | |
| 26B | 2B | Industrial | 30-90 | Low | 115-130 | =>95 | =>120 |
| | | waste heat | | Pressure | | | |
| | | from data | | Steam | | | |
| | | centers | | | | | |
| 26C | 2B | Industrial | 30-90 | Hot water | 50-70 | =>95 | =>120 |
| | | waste heat | | | | | |
| | | from data | | | | | |
| | | centers | | | | | |
| 26D | 2B | Industrial | 30-90 | Hot air | 35-60 | =>95 | =>125 |
| | | waste heat | | | | | |
| | | from data | | | | | |
| | | centers | | | | | |
| 27A | 2B | Industrial | 30-90 | Industrial | 110-145 | =>95 | =>125 |
| | | waste heat | | Steam | | | |
| | | from data | | | | | |
| | | centers | | | | | |
| 27B | 2B | Industrial | 30-90 | Low | 115-130 | =>95 | =>125 |
| | | waste heat | | Pressure | | | |
| | | from data | | Steam | | | |
| | | centers | | | | | |
| 27C | 2B | Industrial | 30-90 | Hot water | 50-70 | =>95 | =>125 |
| | | waste heat | | | | | |
| | | from data | | | | | |
| | | centers | | | | | |
| 27D | 2B | Industrial | 30-90 | Hot air | 35-60 | =>95 | =>125 |
| | | waste heat | | | | | |
| | | from data | | | | | |
| | | centers | | | | | |
| 28A | 2B | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 28B | 2B | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 28C | 2B | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 28D | 2B | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 29A | 2B | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 29B | 2B | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 29C | 2B | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 29D | 2B | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 30A | 2B | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 30B | 2B | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 30C | 2B | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 30D | 2B | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |
| 25A | 2C | Industrial | 30-90 | Industrial | 110-145 | =>95 | =>125 |
| | | waste heat | | Steam | | | |
| 25B | 2C | Industrial | 30-90 | Low | 115-130 | =>95 | =>125 |
| | | waste heat | | Pressure | | | |
| | | | | Steam | | | |
| 25C | 2C | Industrial | 30-90 | Hot water | 50-70 | =>95 | =>125 |
| | | waste heat | | | | | |
| 25D | 2C | Industrial | 30-90 | Hot air | 35-60 | =>95 | =>125 |
| | | waste heat | | | | | |
| 26A | 2C | Industrial | 30-90 | Industrial | 110-145 | =>95 | =>125 |
| | | waste heat | | Steam | | | |
| | | from data | | | | | |
| | | centers | | | | | |
| 26B | 2C | Industrial | 30-90 | Low | 115-130 | =>95 | =>125 |
| | | waste heat | | Pressure | | | |
| | | from data | | Steam | | | |
| | | centers | | | | | |
| 26C | 2C | Industrial | 30-90 | Hot water | 50-70 | =>95 | =>125 |
| | | waste heat | | | | | |
| | | from data | | | | | |
| | | centers | | | | | |
| 26D | 2C | Industrial | 30-90 | Hot air | 35-60 | =>95 | =>125 |
| | | waste heat | | | | | |
| | | from data | | | | | |
| | | centers | | | | | |
| 27A | 2C | Industrial | 30-90 | Industrial | 110-145 | =>95 | =>125 |
| | | waste heat | | Steam | | | |
| | | from data | | | | | |
| | | centers | | | | | |
| 27B | 2C | Industrial | 30-90 | Low | 115-130 | =>95 | =>125 |
| | | waste heat | | Pressure | | | |
| | | from data | | Steam | | | |
| | | centers | | | | | |
| 27C | 2C | Industrial | 30-90 | Hot water | 50-70 | =>95 | =>125 |
| | | waste heat | | | | | |
| | | from data | | | | | |
| | | centers | | | | | |
| 27D | 2C | Industrial | 30-90 | Hot air | 35-60 | =>95 | =>125 |
| | | waste heat | | | | | |
| | | from data | | | | | |
| | | centers | | | | | |
| 28A | 2C | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 28B | 2C | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 28C | 2C | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 28D | 2C | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 29A | 2C | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 29B | 2C | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 29C | 2C | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 29D | 2C | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 30A | 20 | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 30B | 2C | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 30C | 2C | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 30D | 2C | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |
| 31A | 2D | Industrial | 30-90 | Industrial | 110-145 | =>95 | =>125 |
| | | waste heat | | Steam | | | |
| 31B | 2D | Industrial | 30-90 | Low | 115-130 | =>95 | =>125 |
| | | waste heat | | Pressure | | | |
| | | | | Steam | | | |
| 31C | 2D | Industrial | 30-90 | Hot water | 50-70 | =>95 | =>125 |
| | | waste heat | | | | | |
| 31D | 2D | Industrial | 30-90 | Hot air | 35-60 | =>95 | =>125 |
| | | waste heat | | | | | |
| 32A | 2D | Industrial | 30-90 | Industrial | 110-145 | =>95 | =>125 |
| | | waste heat | | Steam | | | |
| | | from data | | | | | |
| | | centers | | | | | |
| 32B | 2D | Industrial | 30-90 | Low | 115-130 | =>95 | =>125 |
| | | waste heat | | Pressure | | | |
| | | from data | | Steam | | | |
| | | centers | | | | | |
| 32C | 2D | Industrial | 30-90 | Hot water | 50-70 | =>95 | =>125 |
| | | waste heat | | | | | |
| | | from data | | | | | |
| | | centers | | | | | |
| 32D | 2D | Industrial | 30-90 | Hot air | 35-60 | =>95 | =>125 |
| | | waste heat | | | | | |
| | | from data | | | | | |
| | | centers | | | | | |
| 33A | 2D | Industrial | 30-90 | Industrial | 110-145 | =>95 | =>125 |
| | | waste heat | | Steam | | | |
| | | from data | | | | | |
| | | centers | | | | | |
| 33B | 2D | Industrial | 30-90 | Low | 115-130 | =>95 | =>125 |
| | | waste heat | | Pressure | | | |
| | | from data | | Steam | | | |
| | | centers | | | | | |
| 33C | 2D | Industrial | 30-90 | Hot water | 50-70 | =>95 | =>125 |
| | | waste heat | | | | | |
| | | from data | | | | | |
| | | centers | | | | | |
| 33D | 2D | Industrial | 30-90 | Hot air | 35-60 | =>95 | =>125 |
| | | waste heat | | | | | |
| | | from data | | | | | |
| | | centers | | | | | |
| 34A | 2D | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 34B | 2D | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 34C | 2D | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 34D | 2D | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 35A | 2D | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 35B | 2D | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 35C | 2D | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 35D | 2D | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 36A | 2D | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 36B | 2D | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 36C | 2D | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 36D | 2D | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |
| 37A | 2E | Industrial | 30-90 | Industrial | 110-145 | =>95 | =>125 |
| | | waste heat | | Steam | | | |
| 37B | 2E | Industrial | 30-90 | Low | 115-130 | =>95 | =>125 |
| | | waste heat | | Pressure | | | |
| | | | | Steam | | | |
| 37C | 2E | Industrial | 30-90 | Hot water | 50-70 | =>95 | =>125 |
| | | waste heat | | | | | |
| 37D | 2E | Industrial | 30-90 | Hot air | 35-60 | =>95 | =>125 |
| | | waste heat | | | | | |
| 38A | 2E | Industrial | 30-90 | Industrial | 110-145 | =>95 | =>125 |
| | | waste heat | | Steam | | | |
| | | from data | | | | | |
| | | centers | | | | | |
| 38B | 2E | Industrial | 30-90 | Low | 115-130 | =>95 | =>125 |
| | | waste heat | | Pressure | | | |
| | | from data | | Steam | | | |
| | | centers | | | | | |
| 38C | 2E | Industrial | 30-90 | Hot water | 50-70 | =>95 | =>125 |
| | | waste heat | | | | | |
| | | from data | | | | | |
| | | centers | | | | | |
| 38D | 2E | Industrial | 30-90 | Hot air | 35-60 | =>95 | =>125 |
| | | waste heat | | | | | |
| | | from data | | | | | |
| | | centers | | | | | |
| 39A | 2E | Industrial | 30-90 | Industrial | 110-145 | =>95 | =>125 |
| | | waste heat | | Steam | | | |
| | | from data | | | | | |
| | | centers | | | | | |
| 39B | 2E | Industrial | 30-90 | Low | 115-130 | =>95 | =>125 |
| | | waste heat | | Pressure | | | |
| | | from data | | Steam | | | |
| | | centers | | | | | |
| 39C | 2E | Industrial | 30-90 | Hot water | 50-70 | =>95 | =>125 |
| | | waste heat | | | | | |
| | | from data | | | | | |
| | | centers | | | | | |
| 39D | 2E | Industrial | 30-90 | Hot air | 35-60 | =>95 | =>125 |
| | | waste heat | | | | | |
| | | from data | | | | | |
| | | centers | | | | | |
| 40 | 2E | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 40B | 2E | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 40C | 2E | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 40D | 2E | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 41A | 2E | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 41B | 2E | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 415C | 2E | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 41D | 2E | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 42A | 2E | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 42B | 2E | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 42C | 2E | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 42D | 2E | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |
| 43A | 2F | Industrial | 30-90 | Industrial | 110-145 | =>95 | =>125 |
| | | waste heat | | Steam | | | |
| 43B | 2F | Industrial | 30-90 | Low | 115-130 | =>95 | =>125 |
| | | waste heat | | Pressure | | | |
| | | | | Steam | | | |
| 43C | 2F | Industrial | 30-90 | Hot water | 50-70 | =>95 | =>125 |
| | | waste heat | | | | | |
| 43D | 2F | Industrial | 30-90 | Hot air | 35-60 | =>95 | =>125 |
| | | waste heat | | | | | |
| 44A | 2F | Industrial | 30-90 | Industrial | 110-145 | =>95 | =>125 |
| | | waste heat | | Steam | | | |
| | | from data | | | | | |
| | | centers | | | | | |
| 44B | 2F | Industrial | 30-90 | Low | 115-130 | =>95 | =>125 |
| | | waste heat | | Pressure | | | |
| | | from data | | Steam | | | |
| | | centers | | | | | |
| 44C | 2F | Industrial | 30-90 | Hot water | 50-70 | =>95 | =>125 |
| | | waste heat | | | | | |
| | | from data | | | | | |
| | | centers | | | | | |
| 44D | 2F | Industrial | 30-90 | Hot air | 35-60 | =>95 | =>125 |
| | | waste heat | | | | | |
| | | from data | | | | | |
| | | centers | | | | | |
| 45A | 2F | Industrial | 30-90 | Industrial | 110-145 | =>95 | =>125 |
| | | waste heat | | Steam | | | |
| | | from data | | | | | |
| | | centers | | | | | |
| 45B | 2F | Industrial | 30-90 | Low | 115-130 | =>95 | =>125 |
| | | waste heat | | Pressure | | | |
| | | from data | | Steam | | | |
| | | centers | | | | | |
| 45C | 2F | Industrial | 30-90 | Hot water | 50-70 | =>95 | =>125 |
| | | waste heat | | | | | |
| | | from data | | | | | |
| | | centers | | | | | |
| 45D | 2F | Industrial | 30-90 | Hot air | 35-60 | =>95 | =>125 |
| | | waste heat | | | | | |
| | | from data | | | | | |
| | | centers | | | | | |
| 46A | 2F | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 46B | 2F | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 46C | 2F | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 46D | 2F | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 47A | 2F | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 47B | 2F | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 47C | 2F | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 47D | 2F | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 48A | 2F | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 48B | 2F | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 48C | 2F | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 48D | 2F | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |
| 49A | 5 | Industrial | 30-90 | Industrial | 110-145 | =>95 | =>125 |
| | | waste heat | | Steam | | | |
| 49B | 5 | Industrial | 30-90 | Low | 115-130 | =>95 | =>125 |
| | | waste heat | | Pressure | | | |
| | | | | Steam | | | |
| 49C | 5 | Industrial | 30-90 | Hot water | 50-70 | =>95 | =>125 |
| | | waste heat | | | | | |
| 49D | 5 | Industrial | 30-90 | Hot air | 35-60 | =>95 | =>125 |
| | | waste heat | | | | | |
| 50A | 5 | Industrial | 30-90 | Industrial | 110-145 | =>95 | =>125 |
| | | waste heat | | Steam | | | |
| | | from data | | | | | |
| | | centers | | | | | |
| 50B | 5 | Industrial | 30-90 | Low | 115-130 | =>95 | =>125 |
| | | waste heat | | Pressure | | | |
| | | from data | | Steam | | | |
| | | centers | | | | | |
| 50C | 5 | Industrial | 30-90 | Hot water | 50-70 | =>95 | =>125 |
| | | waste heat | | | | | |
| | | from data | | | | | |
| | | centers | | | | | |
| 50D | 5 | Industrial | 30-90 | Hot air | 35-60 | =>95 | =>125 |
| | | waste heat | | | | | |
| | | from data | | | | | |
| | | centers | | | | | |
| 51A | 5 | Industrial | 30-90 | Industrial | 110-145 | =>95 | =>125 |
| | | waste heat | | Steam | | | |
| | | from data | | | | | |
| | | centers | | | | | |
| 51B | 5 | Industrial | 30-90 | Low | 115-130 | =>95 | =>125 |
| | | waste heat | | Pressure | | | |
| | | from data | | Steam | | | |
| | | centers | | | | | |
| 51C | 5 | Industrial | 30-90 | Hot water | 50-70 | =>95 | =>125 |
| | | waste heat | | | | | |
| | | from data | | | | | |
| | | centers | | | | | |
| 51D | 5 | Industrial | 30-90 | Hot air | 35-60 | =>95 | =>125 |
| | | waste heat | | | | | |
| | | from data | | | | | |
| | | centers | | | | | |
| 52A | 5 | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 52B | 5 | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 52C | 5 | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 52D | 5 | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 53A | 5 | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 53B | 5 | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 53C | 5 | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 53D | 5 | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 54A | 5 | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 54B | 5 | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 54C | 5 | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 54D | 5 | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |
| 55A | 6 | Industrial | 30-90 | Industrial | 110-145 | =>95 | =>125 |
| | | waste heat | | Steam | | | |
| 55B | 6 | Industrial | 30-90 | Low | 115-130 | =>95 | =>125 |
| | | waste heat | | Pressure | | | |
| | | | | Steam | | | |
| 55C | 6 | Industrial | 30-90 | Hot water | 50-70 | =>95 | =>125 |
| | | waste heat | | | | | |
| 55D | 6 | Industrial | 30-90 | Hot air | 35-60 | =>95 | =>125 |
| | | waste heat | | | | | |
| 56A | 6 | Industrial | 30-90 | Industrial | 110-145 | =>95 | =>125 |
| | | waste heat | | Steam | | | |
| | | from data | | | | | |
| | | centers | | | | | |
| 56B | 6 | Industrial | 30-90 | Low | 115-130 | =>95 | =>125 |
| | | waste heat | | Pressure | | | |
| | | from data | | Steam | | | |
| | | centers | | | | | |
| 56C | 6 | Industrial | 30-90 | Hot water | 50-70 | =>95 | =>125 |
| | | waste heat | | | | | |
| | | from data | | | | | |
| | | centers | | | | | |
| 56D | 6 | Industrial | 30-90 | Hot air | 35-60 | =>95 | =>125 |
| | | waste heat | | | | | |
| | | from data | | | | | |
| | | centers | | | | | |
| 57A | 6 | Industrial | 30-90 | Industrial | 110-145 | =>95 | =>125 |
| | | waste heat | | Steam | | | |
| | | from data | | | | | |
| | | centers | | | | | |
| 57B | 6 | Industrial | 30-90 | Low | 115-130 | =>95 | =>125 |
| | | waste heat | | Pressure | | | |
| | | from data | | Steam | | | |
| | | centers | | | | | |
| 57C | 6 | Industrial | 30-90 | Hot water | 50-70 | =>95 | =>125 |
| | | waste heat | | | | | |
| | | from data | | | | | |
| | | centers | | | | | |
| 57D | 6 | Industrial | 30-90 | Hot air | 35-60 | =>95 | =>125 |
| | | waste heat | | | | | |
| | | from data | | | | | |
| | | centers | | | | | |
| 58A | 6 | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 58B | 6 | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 58C | 6 | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 58D | 6 | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 59A | 6 | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 59B | 6 | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 59C | 6 | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 59D | 6 | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 60A | 6 | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 60B | 6 | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 60C | 6 | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 60D | 6 | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |
| 61A | 7 | Industrial | 30-90 | Industrial | 110-145 | =>95 | =>125 |
| | | waste heat | | Steam | | | |
| 61B | 7 | Industrial | 30-90 | Low | 115-130 | =>95 | =>125 |
| | | waste heat | | Pressure | | | |
| | | | | Steam | | | |
| 61C | 7 | Industrial | 30-90 | Hot water | 50-70 | =>95 | =>125 |
| | | waste heat | | | | | |
| 61D | 7 | Industrial | 30-90 | Hot air | 35-60 | =>95 | =>125 |
| | | waste heat | | | | | |
| 62A | 7 | Industrial | 30-90 | Industrial | 110-145 | =>95 | =>125 |
| | | waste heat | | Steam | | | |
| | | from data | | | | | |
| | | centers | | | | | |
| 62B | 7 | Industrial | 30-90 | Low | 115-130 | =>95 | =>125 |
| | | waste heat | | Pressure | | | |
| | | from data | | Steam | | | |
| | | centers | | | | | |
| 62C | 7 | Industrial | 30-90 | Hot water | 50-70 | =>95 | =>125 |
| | | waste heat | | | | | |
| | | from data | | | | | |
| | | centers | | | | | |
| 62D | 7 | Industrial | 30-90 | Hot air | 35-60 | =>95 | =>125 |
| | | waste heat | | | | | |
| | | from data | | | | | |
| | | centers | | | | | |
| 63A | 7 | Industrial | 30-90 | Industrial | 110-145 | =>95 | =>125 |
| | | waste heat | | Steam | | | |
| | | from data | | | | | |
| | | centers | | | | | |
| 63B | 7 | Industrial | 30-90 | Low | 115-130 | =>95 | =>125 |
| | | waste heat | | Pressure | | | |
| | | from data | | Steam | | | |
| | | centers | | | | | |
| 63C | 7 | Industrial | 30-90 | Hot water | 50-70 | =>95 | =>125 |
| | | waste heat | | | | | |
| | | from data | | | | | |
| | | centers | | | | | |
| 63D | 7 | Industrial | 30-90 | Hot air | 35-60 | =>95 | =>125 |
| | | waste heat | | | | | |
| | | from data | | | | | |
| | | centers | | | | | |
| 64A | 7 | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 64B | 7 | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 64C | 7 | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 64D | 7 | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | bottling | | | | | |
| 65A | 7 | Industrial | 30-90 | Industrial | 110-145 | =>95 | =>125 |
| | | waste heat | | Steam | | | |
| | | from beverage | | | | | |
| | | manufacturing | | | | | |
| | | and/or | | | | | |
| | | bottling | | | | | |
| 65B | 7 | Industrial | 30-90 | Low | 115-130 | =>95 | =>125 |
| | | waste heat | | Pressure | | | |
| | | from beverage | | Steam | | | |
| | | manufacturing | | | | | |
| | | and/or | | | | | |
| | | bottling | | | | | |
| 65C | 7 | Industrial | 30-90 | Hot water | 50-70 | =>95 | =>125 |
| | | waste heat | | | | | |
| | | from beverage | | | | | |
| | | manufacturing | | | | | |
| | | and/or | | | | | |
| | | bottling | | | | | |
| 65D | 7 | Industrial | 30-90 | Hot air | 35-60 | =>95 | =>125 |
| | | waste heat | | | | | |
| | | from beverage | | | | | |
| | | manufacturing | | | | | |
| | | and/or | | | | | |
| | | processing | | | | | |
| 66A | 7 | Industrial | 30-90 | Industrial | 110-145 | =>95 | =>125 |
| | | waste heat | | Steam | | | |
| | | from dairy | | | | | |
| | | manufacturing | | | | | |
| | | and/or | | | | | |
| | | processing | | | | | |
| 66B | 7 | Industrial | 30-90 | Low | 115-130 | =>95 | =>125 |
| | | waste heat | | Pressure | | | |
| | | from dairy | | Steam | | | |
| | | manufacturing | | | | | |
| | | and/or | | | | | |
| | | processing | | | | | |
| 66C | 7 | Industrial | 30-90 | Hot water | 50-70 | =>95 | =>125 |
| | | waste heat | | | | | |
| | | from dairy | | | | | |
| | | manufacturing | | | | | |
| | | and/or | | | | | |
| | | processing | | | | | |
| 66D | 7 | Industrial | 30-90 | Hot air | 35-60 | =>95 | =>125 |
| | | waste heat | | | | | |
| | | from dairy | | | | | |
| | | manufacturing | | | | | |
| | | and/or | | | | | |
| | | processing | | | | | |

Applicants have found that the refrigerant compositions, systems and methods of the present invention are able to satisfy in an exceptional and unexpected way the need for HTHP systems having excellent performance with respect to environmental impact while at the same time providing other important performance characteristics, such as, but not limited to, high capacity and efficiency, flammability that is Class 1 or 2L, acceptable toxicity and advantageous capacity and COP.

In preferred embodiments the present compositions provide alternatives and/or replacements for working fluids currently used in high temperature heat pump applications, particularly and preferably as alternatives and/or replacements for CFC-114 and R-1233zd(Z).

In preferred embodiments, each of the methods of the present invention, including Heat Transfer Method 1 and HTHP Methods 1-66, utilizes a refrigerant of the present invention, including each of Refrigerants 1-6, wherein the critical temperature of the refrigerant is greater than the temperature of the high temperature heat sink, and preferably of about 150° C. to about 160° C.

In preferred embodiments, each of the methods of the present invention, including Heat Transfer Method 1 and HTHP Methods 1-66, utilizes a refrigerant of the present invention, including each of Refrigerants 1-6, wherein the critical temperature of the refrigerant is greater than the temperature of the high temperature heat sink and wherein the refrigerant critical temperature is about 160° C. or less.

### Heat Transfer Compositions

The compositions of the present invention are those which include refrigerants of the present invention, including each of Refrigerants 1-6. Applicants have found that use of the components of the present invention within the stated ranges is important to achieve the important but difficult to achieve combinations of properties exhibited by the present compositions, particularly in the preferred HTHP systems and methods.

The compositions of the present invention are those which include refrigerants of the present invention, including each of Refrigerants 1-6, having a critical temperature of about 155° C.

The heat transfer compositions of the present invention may include, in addition to the present refrigerants, other components for the purpose of enhancing or providing certain functionality to the heat transfer composition, or in some cases to reduce the cost of the composition. For example, heat transfer compositions which include the present refrigerants, including Refrigerants 1-6, when used in the preferred vapor compression HTHP systems, will also include one or more lubricants. The amount of the lubricant in the heat transfer composition can vary even within the HTHP system, generally in amounts of from as little as 0.1 percent by weight to up to about 20 percent by weight. For a given system, the relative amount of the lubricant present in the system as a percentage of the total amount of lubricant and refrigerant in system can also vary widely, such as from about 30 to about 50 percent by weight.

Applicants have found that several lubricants are useful in connection with present refrigerants, systems and methods, including mineral oil, alkyl benzene, poly alpha olefins (POAs), Polyol Esters (POEs) and Poly Vinyl Ethers (PVEs), PAG oils, silicone oil, and other lubricants that have been used in refrigeration machinery with previously used hydrofluorocarbon (HFC) refrigerants. Commercially available POE lubricants include neopentyl glycol dipelargonate, which is available as Emery 2917 (registered trademark) and Hatcol 2370 (registered trademark). Preferred lubricants include POEs and PVEs. Of course, different mixtures of different types of lubricants may be used.

### Heat Transfer Methods and Systems

The present methods, systems and compositions are thus adaptable for use in connection with a wide variety of heat transfer systems in general and HTHP systems in particular. The preferred high temperature heat pump systems include those in which the refrigerants of the present invention, including each of Refrigerants 1-6, condense at a temperature of greater than 90° C., and even more preferably greater than about 100° C. Examples of such systems include, but are not limited to, those used as replacements for boilers by the industry, district heating heat pumps (including shallow geothermal district heating systems), and commercial heat pumps. Examples include water-to-water heat pumps for shopping centers. They can also be used in the oil or mining industry where heat source is readily available. The compressor is usually of centrifugal type and screw type, but other types like scroll may also be used. The heat exchangers can be direct expansion shell-tube type (preferably with the refrigerant on the tube-side) and brazed plate heat exchanger. The heat pump systems of the present invention also include in preferred embodiments an economizer with vapor injection and suction line heat exchangers.

As mentioned above, the present invention achieves exceptional advantages in connection with heat pump systems, including particularly and preferably high temperature heat pump systems. Non-limiting examples of such systems are provided in the Examples below. The examples below provide typical conditions and parameters for certain high temperature heat pumps but do not limit the broad scope of the operation of the systems and methods of the present invention. To this end, the conditions used in the examples are generally representative of but are not considered limiting of the invention, as one of skill in the art will appreciate that they may be varied based on one or more of a myriad of factors, including but not limited to, ambient conditions, intended application, time of year, and the like. Such examples are also not necessarily limiting to the definition of the term “high temperature heat pump system.”

It is contemplated that in certain embodiments the present invention provides methods of reducing the cost of providing a high temperature heat pump by replacing at least a substantial portion of the heat transfer fluid (including the refrigerant and optionally the lubricant) in an existing system with a refrigerant of the present invention, including each of Refrigerants 1-6, One advantage of the present replacement methods is the ability to achieve a reduced cost for the system as a result of the ability to use in the same application a compressor having a substantially reduced displacement compared to previously used refrigerants, including particularly 1233zd(E). In certain preferred embodiments the, compressor displacement is about 90% or less than the displacement required to achieve in the system the same capacity using 1233zd(E), preferably 85% or less than the displacement required to achieve in the system the same capacity using 1233zd(E), even more preferably at least about preferably 80% or less than the displacement required to achieve in the system the same capacity using 1233zd(E). Such an unexpected aspect of the present invention provides the ability to operate with the cost reduction methods as described here, including particularly by decreasing the size and cost of the compressor(s) used in the system.

### EXAMPLES

The following examples are provided for the purpose of illustrating the present invention but without limiting the scope thereof.

### Comparative Example 1

A HTHP system as illustrated generally in FIG. 1 (that is, without a vapor injector economizer and without a suction line heat exchanger) is operated with a refrigerant consisting of 1233zd(E) under the following operating conditions:
1. Heat Sink Temperature=100° C.
2. Heat Source Temperature=25° C.
3. Refrigerant Condensing temperature=130° C.
4. Condenser sub-cooling=5.0° C.
5. Refrigerant Evaporating temperature=60° C.
6. Evaporator Superheat=5.0° C.
7. Isentropic Efficiency=70%
8. Volumetric Efficiency=95%

The HTHP system is operated, and the coefficient of performance (COP) and capacity of the system are determined (based on the pressure drop and heat transfer in the connecting lines (suction and liquid lines) considered to be negligible, and heat leakage through the compressor shell being ignored). COP is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration to the energy applied by the compressor in compressing the vapor. The capacity of a refrigerant represents the amount of cooling or heating it provides and provides some measure of the capability of a compressor to pump quantities of heat for a given volumetric flow rate of refrigerant and other operating conditions. In other words, given a specific compressor and set of operating conditions, a refrigerant with a higher capacity will deliver more cooling or heating power. One means for estimating COP and capacity of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988).

For the purposes of comparison, the COP and capacity of the HTHP operated as in this Comparative Example 1 using a refrigerant consisting of 1233zd(E) is set as the base line and referred to in the following example as having a base line with a value of 100% for COP and 100% for volumetric capacity.

### Comparative Examples C1-C5—High Temperature Heat Pump

Comparative Example 1 is repeated except using four refrigerant blends as disclosed in U.S. Pat. No. 9,850,414. The four refrigerants are identified as C1-C5 in Table ExC2 below:

TABLE ExC1-C5

| | Components | | | | |
|---|---|---|---|---|---|
| | R134a | R1233zd(E) | R1234ze(E) | | Properties |
| Refrigerant | (wt %) | (wt %) | (wt %) | Total | GWP |
| C1 | 15.0 | 85.0 | 0 | 100% | 215.4 |
| C2 | 10.0 | 90.0 | 0 | 100% | 143.9 |
| C3 | 5.0 | 95.0 | 0 | 100% | 72.5 |
| C4 | 0 | 65.0 | 35.0 | 100% | 3.1 |
| C5 | 0 | 75.0% | 25.0% | 100% | 2.5 |

As can be seen from the table above, the refrigerant identified as C1 is not an acceptable refrigerant at least for the reason that it has a GWP greater than 150. The remaining blends C2-C5 have GWP values less than 150 and are therefore evaluated for performance in the high temperature heat pump described in Comparative Example 1. The following results in terms of COP and Capacity for the conditions specified of Comparative Example 1 but using refrigerants C2-C5 are determined and reported in Table ExC2-C5 below:

TABLE ExC2-C5

| | | Operating Performance Relative | |
|---|---|---|---|
| | Refrigerant | to 1233zd(E) | |
| Example | (wt % 134a/1233zd(E)/ | CAPACITY | COP |
| No. | 1234ze(E)) | (% 1233ZD(E)) | (% 1233ZD(E)) |
| ExC2 | C2 (10/90/0) | 115.8% | 97.6% |
| ExC3 | C3 (5/95/0) | 108% | 98.9% |
| ExC4 | C4 (0/65/35) | 131% | 90.2% |
| ExC5 | C5 (0/75/25) | 123.2% | 93.6% |

As can be seen from Table ExC2-C5 above, while each of refrigerants C2 and C3 has a COP that is greater than 95% relative to 1233zd(E) in the system, C2 and C3 have capacities in the HTHP system of 115.8% and 108%, respectively, relative to capacity of 1233zd(E) in the system, thus showing that the use of either of these refrigerants is not able to satisfy the minimum capacity of 120% as required by the present invention for such systems. Furthermore, while each of refrigerants C4 and C5 has a capacity that is greater than 120% relative to 1233zd(E) in the system, C4 and C5 have COPs in the HTHP system of 90.2% and 93.6%, respectively, relative to COP of 1233zd(E) in the system, thus showing that the use of either of these refrigerants is not able to satisfy the minimum COP of 95% as required by the present invention for such systems.

### Examples 1-R1 and 1-R2—High Temperature Heat Pump

Two refrigerants according to the present invention are formed in accordance with the blends identified as R1 and R2 in Table Ex1R1-R2 below, and each refrigerant is found to be a Class A1 refrigerant and to have a global warming potential (“GWP)” determined in accordance with the Definitions above and as reported in the table below:

TABLE Ex1R1-R2

| | Components | | | | |
|---|---|---|---|---|---|
| | R134a | R1233zd(E) | R1234ze(E) | | |
| | (wt %) | (wt %) | (wt %) | | |
| | CT - | CT - | CT | | Properties |
| Refrigerant | 213.9 C | 160 C | 153.7 C | Total | GWP |
| R1 | 15% | 85.6% | 4.1% | 100% | 148.4 |
| R2 | 10.3% | 84% | 5.7% | 100% | 148.5 |

As can be seen from the table above, applicants have found that each of refrigerants R1 and R2 has not only a GWP of less than 150 but also is a Class A1 refrigerant.

Each of the refrigerants R1 and R2 is then utilized in the same high temperature heat pump as described in and under the same operating conditions as specified in Comparative Example 1. The following results in terms of COP and Capacity for the conditions specified above are determined and reported in Table Ex1B below:

TABLE X1B

| | | Operating Performance Relative | |
|---|---|---|---|
| | Refrigerant | to 1233zd(E) | |
| Example | (wt % 134a/1233zd(E)/ | CAPACITY | COP |
| No. | 1234ze(E)) | (% 1233ZD(E)) | (% 1233ZD(E)) |
| R1 | A1 (10.3/85.6/4.1) | 120% | 96.4% |
| R2 | A2 (10.3/84.0/5.7) | 121.5% | 96.0% |

As can be seen from TableEx1B above, each of the refrigerants R1 and R2 of the present invention is unexpectedly able to at once achieve a GWP of less than 150, a Class A1 flammability, and to operate in the HTHP system with a COP that is 95% or greater and a capacity that is 120% or greater than the COP and capacity of 1233zd(E) in the same HTHP system and operating under the same set of specified conditions. The ability to achieve this combination of results is advantageous but not expected.

### Example 1-R5—High Temperature Heat Pump

The procedure of Example 1-R1 and 1-R2 is repeated, except that refrigerant R5 as defined in Table Ex1R5 below is used. This refrigerant R5 is found to be a Class A1 refrigerant and to have a global warming potential (“GWP)” determined in accordance with the Definitions above of less than 150.

TABLE Ex1R5

| | Components | | | | |
|---|---|---|---|---|---|
| | R134a | R1233zd(E) | R1234ze(E) | | |
| | (wt %) | (wt %) | (wt %) | | |
| | CT - | CT - | CT | | Properties |
| Refrigerant | 213.9 C | 160 C | 153.7 C | Total | GWP |
| R5 | 10% | 83.2% | 7.8% | 100% | <150 |

Performance is as good as or better than the performance reported for R1 and R2 is achieved.

### Example 2-R3 and R4 in High Temperature Heat Pump Used in Industrial Systems with a Heat Source Temperature of Above 60° C. And Refrigerant Condensing Temperature of 140° C.

An industrial heat pump system having a basic structure as illustrated in FIG. 1 is provided and is used to supply heat for an industrial process in the form of direct heating, heating a secondary fluid or by generating steam using refrigerants R1 and R2. Refrigerants of the present invention identified as R3 and R4 in the Table ExR3-R4 below are also used in the system.

TABLE EXR3-R4

| | Components | | | | |
|---|---|---|---|---|---|
| | R134a | R1233zd(E) | R1234ze(E) | | |
| | (wt %) | (wt %) | (wt %) | | |
| | CT - | CT - | CT | | Properties |
| Refrigerant | 213.9 C | 160 C | 153.7 C | Total | GWP |
| R3 | 10% | 81.5% | 8.5% | 100% | 148.4 |
| R4 | 2.5% | 77% | 20.5% | 100% | <40 |

This system uses residual heat from another process (i.e., waste heat) at temperatures above 60° C. as the heat source for its evaporator and provides heat to a heat sink at a temperature of from about 90° C.-135° C. The system is operated under the following conditions using each of R1-R4 as the refrigerant:
1. Refrigerant condensing temperature=140° C.
2. Condenser sub-cooling=5° C.
3. Refrigerant evaporating temperature=60° C.
4. Evaporator Superheat=5° C.
5. Isentropic Efficiency=65%
6. Volumetric Efficiency=100%

### Example 2-R5—In High Temperature Heat Pump Used in Industrial Systems with a Heat Source Temperature of Above 60° C. And Refrigerant Condensing Temperature of 140° C.

The procedure of Example 2-R3 and R4 is repeated, except that refrigerant R5 as defined in Table Ex1R5 above is used. Performance is as good as or better than the performance reported for R3 and R4 is achieved.

### Example 3 R1-R4 Use in High Temperature Heat Pump with Vapor Injection Economizer

Refrigerants R1-R4 according to the present invention as described in the prior examples are used in a HTHP equipped with a vapor injection economizer (VIE) as illustrated in FIG. 2. While the use of refrigerants R1 and R2 in a system without a vapor injection economizer as described in Example 1 is able to achieve capacities above 120%, the highly desirable capacity of 125% or greater was not achieved in that system using those refrigerants. Unexpectedly, it was found that a capacity of 125% or greater, while maintaining a COP of 95% or greater, was possible when refrigerants R1-R4 are used in a HTHP system with a vapor injection economizer, and the results using these refrigerants in such a system are reported in Table Ex3 below:

TABLE x3
HTHP with VIE

| | | Operating Performance Relative | |
|---|---|---|---|
| | Refrigerant | to 1233zd(E) | |
| Example | (wt % 134a/1233zd(E)/ | CAPACITY | COP |
| No. | 1234ze(E) | (% 1233ZD(E)) | (% 1233ZD(E)) |
| R1 | A1 (10/79.5/10.5) | 126% | 96.55% |
| R2 | A2 (10/80.5/9.5) | 124.9% | 96.4% |
| R3 | A3 (10/81.5/8.5) | 123.8% | 96.25% |
| R4 | A4 (2.5/77/20.5) | 125.0% | 96.3% |

As can be seen from the Tables above, each of the refrigerants R1-R2 when used in a HTHP system with a VIE is unexpectedly able to at once achieve a GWP of less than 150, a Class A1flammability, a COP that is above 96% and a capacity that is about 125% or greater than the capacity of 1233z(E) in that same system, i.e., the base line system for this example includes a VIE with 100% 1233zd(E). It is thus seen that the refrigerants of the present in the preferred systems of the present invention which include a VIE produced an unexpectedly large improvement in performance, including for R1, R2 and R4 the ability to achieve a capacity performance that is about 125% or higher and at the same time a COP performance that is at least 96%.

### Example 3-R5—Use in High Temperature Heat Pump with Vapor Injection Economizer

The procedure of Example 3—R1-R4 is repeated, except that refrigerant R5 as defined in Table Ex1R5 above is used. Performance is as good as or better than the performance reported for R1-R4 is achieved.

### Example 3-R1-R4 in High Temperature Heat Pump Used in Industrial Systems with a Heat Source Temperature of Above 60° C. And Refrigerant Condensing Temperature of 140° C. And an VIE

Example 2 is repeated, except the system is modified to include a VIE. An unexpected improvement in performance similar to Example 3 is achieved.

### Example 4-R5—In High Temperature Heat Pump Used in Industrial Systems with a Heat Source Temperature of Above 60° C. And Refrigerant Condensing Temperature of 140° C. And an VIE

The procedure of Example 4-R1-R4 is repeated, except that refrigerant R5 as defined in Table Ex1R5 above is used. Performance is as good as or better than the performance reported for R1-R4 is achieved.

What is claimed is:

1. A refrigerant consisting essentially of the following three components in the following relative concentrations:
(1) from 72% to 85.5% by weight of HFO-1233zd(E);
(2) from 4.5% to 28% by weight of HFO-1234ze(E); and
(3) from 1% to 11% by weight of HFC-134a.

2. The refrigerant of claim 1 consisting essentially of the following three components in the following relative concentrations:
(1) from 77% to 83% by weight of HFO-1233zd(E);
(2) from 7% to 21% by weight of HFO-1234ze(E); and
(3) from 2% to 11% by weight of HFC-134a.

3. The refrigerant of claim 1 consisting essentially of the following three components in the following relative concentrations:
(1) from 79% to 83% by weight of HFO-1233zd(E);
(2) from 8% to 11% by weight of HFO-1234ze(E); and
(3) from 9% to 11% by weight of HFC-134a.

4. The refrigerant of claim 1 consisting essentially of the following three components in the following relative concentrations:
(1) from about 82% to about 86% by weight of HFO-1233zd(E);
(2) from about 4% to about 9% by weight of HFO-1234ze(E); and
(3) from about 7% to about 10.3% by weight of HFC-134a.

5. The refrigerant of claim 1 consisting essentially of the following three components in the following relative concentrations:
(1) from 79.5% to 82.5% by weight of HFO-1233zd(E);
(2) from 7.5% to 10.5% by weight of HFO-1234ze(E); and
(3) from 9.5% to 10.5% by weight of HFC-134a.

6. A refrigerant according to claim 1 wherein said refrigerant is a Class A1 refrigerant.

7. A refrigerant according to claim 1 wherein said refrigerant has a GWP of 150 or less.

8. A refrigerant according to claim 1 having a critical temperature of 150° C. or greater.

9. A method of producing heat in a high temperature heat pump comprising condensing in a condenser a refrigerant according to claim 1 at a temperature in the range of from about 70° C. to about 145° C.

10. The method of claim 9 wherein said refrigerant has a volumetric capacity in said system that is at least about 120% of the volumetric capacity of R-1233zd(E) in said system and wherein said refrigerant has a COP in said system that is at least 96% of the COP of R-1233zd(E) in said system.

11. A method of heating a heat sink comprising a fluid or body to be heated comprising:
a. providing a vapor compression refrigeration system comprising a compressor for compressing a refrigerant in a vapor phase, a condenser transferring heat to the heat sink by condensing said vapor phase refrigerant at a temperature of about 70° C. to about 145° C., and a direct expansion evaporator transferring heat from a heat source at a temperature of about 80° C. or less to said refrigerant in the liquid phase, wherein said refrigerant consists essentially of the following three components in the following relative concentrations:
i. from 72% to 85.5% by weight of HFO-1233zd(E);
ii. from 4.5% to 15% by weight of HFO-1234ze(E); and
iii. from 1% to 11% by weight of HFC-134a; and
b. condensing said refrigerant in said condenser, wherein said refrigerant has a volumetric capacity in said system that is at least about 120% of the volumetric capacity of R-1233zd(E) in said system.

12. The method of claim 11 wherein said refrigerant consists essentially of the following three components in the following relative concentrations:
(1) from about 77% to about 83% by weight of HFO-1233zd(E);
(2) from about 7% to about 21% by weight of HFO-1234ze(E); and
(3) from about 2% to about 11% by weight of HFC-134a.

13. The method of claim 11 wherein said refrigerant consists essentially of the following three components in the following relative concentrations:
(1) from 79% to 83% by weight of HFO-1233zd(E);
(2) from 7% to 11% by weight of HFO-1234ze(E); and
(3) from 9% to 11% by weight of HFC-134a.

14. The method of claim 11 wherein said refrigerant consists essentially of the following three components in the following relative concentrations:
(1) from 82% to 86% by weight of HFO-1233zd(E);
(2) from 4% to 9% by weight of HFO-1234ze(E); and
(3) from 7% to 10.3% by weight of HFC-134a.

15. The method of claim 11 wherein said refrigerant consists essentially of the following three components in the following relative concentrations:
(1) from 79.5% to 21.5% by weight of HFO-1233zd(E);
(2) from 7.5% to 10.5% by weight of HFO-1234ze(E); and
(3) from 9.5% to 10.5% by weight of HFC-134a.

16. The method according to claim 1 wherein said refrigerant is a Class A1 refrigerant.

17. The method according to claim 1 wherein said refrigerant has a GWP of 150 or less.

18. The method according to claim 1 wherein said refrigerant has a critical temperature of 150° C. or greater.

19. The method according to claim 1 wherein said refrigerant has a COP in said system that is at least 96% of the COP of R-1233zd(E) in said system.

20. The method according to claim 1 wherein said refrigerant has a volumetric capacity in said system that is at least about 125% of the volumetric capacity of R-1233zd(E) in said system.
